(19) United States
(12) Patent Application Publication
(10) Pub. No.: US 2022/0144362 A1
(43) Pub. Date: May 12, 2022

(54) AUXILIARY LIGHTING SYSTEM FOR THREE-WHEELED MOTORCYCLES

(71) Applicant: X'avier F. Noel, Cameron, NC (US)

(72) Inventor: X'avier F. Noel, Cameron, NC (US)

(21) Appl. No.: 17/094,048

(22) Filed: Nov. 10, 2020

(51) Int. Cl. B62J 6/04; B62J 43/30; B62J 6/015; B62J 45/41; B62J 6/05; B62J 6/165; B62J 6/26; F21V 23/04; F21S 9/03; F21S 43/14

(52) U.S. Cl. CPC B62J 6/04; B62J 43/30; B62J 6/015; B62J 45/41; B62J 6/05; B62K 5/027; B62J 6/26; F21V 23/0464; F21S 9/03; F21S 43/14; B62J 6/165

(57) ABSTRACT

An auxiliary lighting system for a three-wheeled motorcycle having a pair of rear wheels is disclosed, wherein the lighting system is affixed to a forward-facing portion and/or side portion of the rear fenders thereof.

### BACKGROUND

Three-wheeled motorcycles are generally considered to be safer than their conventional two-wheeled counterparts. One safety hazard associated with three-wheeled motorcycles having two rear wheels, however, is that they are not equipped with forward-facing lights on the rear fenders. Accordingly, when approached at nighttime, i.e., with the headlamp operational, a three-wheeled motorcycle can appear to incoming traffic to be a two-wheeled motorcycle. That is, the rear fenders are not visible to incoming traffic. Incoming traffic therefor underestimates the total width, e.g., from the outside of one rear fender to the outside of the other rear fender, of a three-wheeled motorcycle.

### SUMMARY

In some aspects, the presently disclosed subject matter provides an auxiliary lighting system for a three-wheeled motorcycle, wherein the three-wheeled motorcycle has two rear wheels and a single front wheel in a delta configuration, the two rear wheels each partially enclosed by a rear fender, wherein the auxiliary lighting system comprises one or more light elements adapted to be affixed to a forward-facing portion and/or side portion of each rear fender.

In some aspects, the one or more light elements are selected from the group consisting of one or more light-emitting diodes (LEDs), one or more halogen lights, one or more high-intensity discharge lamps, and combinations thereof.

In particular aspects, the one or more LEDs is selected the group consisting of a flexible LED light strip, LED light tube, and LED cluster. In certain aspects, the one or more LEDs have a color selected from the group consisting of white, blue, ice blue, red, green, pink, purple, orange, yellow, and combinations thereof.

In some aspects, the auxiliary lighting system comprises a halogen light or a high-intensity discharge lamp, and the auxiliary lighting system further comprises a lens. In certain aspects, the lens includes a clear lens, a colored lens, or combinations thereof.

In some aspects, the auxiliary lighting system is directly wired into an electrical system of the three-wheeled motorcycle or has a separate power source. In certain aspects, the separate power source is selected from an external battery and a solar panel.

In some aspects, the auxiliary lighting system is configured to be electrically controlled to be activated and deactivated. In certain aspects, the auxiliary lighting system is electronically controlled through an existing control system of the three-wheeled motorcycle or is controlled by a standalone switching system. In particular aspects, the standalone switching system comprises a smartphone. In some aspects, the auxiliary lighting system further comprises a twilight sensor.

In some aspects, the auxiliary lighting system can be adapted for use as running lights, parking lights, directional indicators, emergency flashers, and combinations thereof.

Certain aspects of the presently disclosed subject matter having been stated hereinabove, which are addressed in whole or in part by the presently disclosed subject matter, other aspects will become evident as the description proceeds when taken in connection with the accompanying Drawings as best described herein below.

### BRIEF DESCRIPTION OF THE DRAWINGS

Having thus described the presently disclosed subject matter in general terms, reference will now be made to the accompanying Figures, which are not necessarily drawn to scale, and wherein:

FIG. 1 is a side view of a three-wheeled motorcycle known in the art. Adapted from U.S. Pat. No. 7,770,683 to Keogh et al. for Three-wheeled vehicle, issued Aug. 10, 2010, which is incorporated herein by reference in its entirety;

FIG. 2 is an exploded, front perspective view of a trunk body of a three-wheeled motorcycle having two rear fenders fitted with the presently disclosed auxiliary lighting system on the forward-facing portion of each rear fender; and

FIG. 3 is a front perspective view of a trunk body of the three-wheeled motorcycle of FIG. 2 having two rear fenders fitted with the presently disclosed auxiliary lighting system on the forward-facing portion and side portion of each rear fender.

### DETAILED DESCRIPTION

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

Three-wheeled motorcycles, also referred as “trikes,” are becoming more popular among motorcycle enthusiasts. Three-wheeled motorcycles include those having two wheels in the front or two wheels in the rear. The presently disclosed subject matter relates to three-wheeled motorcycles having two wheels in the rear and a single front wheel in a delta configuration. Such rear-wheeled trikes include those offered by original equipment manufacturers, e.g., Harley-Davidson, including the Tri Glide® Ultra, CVO™ TRI GLIDE®, and Freewheeler®, and Honda, including the Gold Wing 1500 SE and Gold Wing 800, Aspencade, Valkyrie, and Shadow Sabre, and the Indian Roadmaster. Rear-wheeled trikes also include those retrofitted with aftermarket conversion kits, e.g., conversion kits from Voyager.

Three-wheeled motorcycles are generally considered to be safer than their conventional two-wheeled counterparts. One safety hazard associated with three-wheeled motorcycles having two rear wheels, however, is that they are not equipped with forward-facing lights on the rear fenders. Accordingly, when approached at nighttime, i.e., with the headlamp operational, a three-wheeled motorcycle can appear to incoming traffic to be a two-wheeled motorcycle. That is, the rear fenders are not visible to incoming traffic. Incoming traffic therefor underestimates the total width, e.g., from the outside of one rear fender to the outside of the other rear fender, of a three-wheeled motorcycle. The lack of visibility of the rear fenders of a trike therefore creates a safety hazard for the rider.

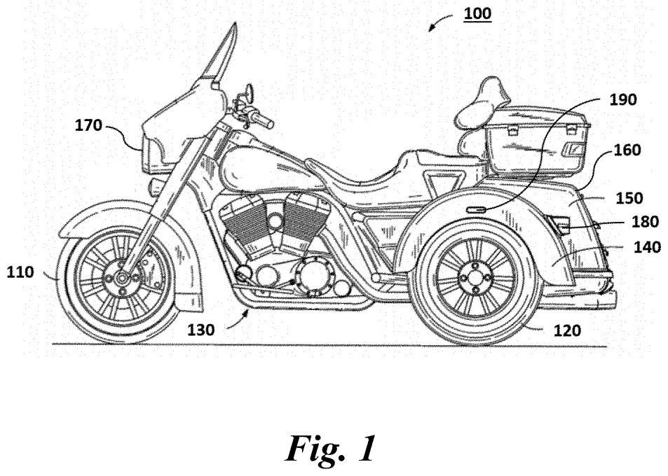

The presently disclosed subject matter addresses this safety hazard by providing an auxiliary lighting system for three-wheeled motorcycles. Shown in FIG. 1 is a side view of a three-wheeled motorcycle known in the art, adapted from U.S. Pat. No. 7,770,683 to Keogh et al. for Three-wheeled vehicle, issued Aug. 10, 2010, which is incorporated herein by reference in its entirety. Referring now to FIG. 1, three-wheeled motorcycle 100 includes a front wheel 110 and a pair of rear wheels 120 that are rotatably supported by a rear axle assembly (not shown) that is coupled to a main frame assembly 130. The pair of rear wheels 120 are at least partially covered by a pair of rear fenders 140. The respective rear fenders are coupled to either side of a trunk body 150 of three-wheeled motorcycle 100, e.g., a trunk body comprising a storage compartment 160. In some embodiments, the pair of rear fenders 140 are separate and distinct components from body 150. In such embodiments, the pair of rear fenders 140 are secured to the body by fasteners (e.g., bolts, screws, rivets, and the like). In some embodiments, the rear fenders are integrally formed as a single piece with body 150 comprising storage compartment 160.

Three-wheeled motorcycles known in the art comprise lighting systems including a headlight, a pair of taillights, directional indicators, reflectors, and the like. Referring once again to FIG. 1, three-wheeled motorcycle 100 comprises a forward-facing headlight 170, a taillight 180 affixed to a rear-facing portion of each respective rear fender 140, and a reflector 190 affixed to a side portion of each respective rear fender 140. Headlight 170 is positioned at the front of motorcycle 100 and illuminates an area in a forward-looking direction and also makes the front portion of motorcycle 100 visible to oncoming traffic. A pair of taillights 180 makes the rear of motorcycle 100 visible to vehicles behind it and also indicates when the brakes are applied. The pair of taillights 180 also can be used as directional indicators, i.e., turn signal lights. Separate turn signals (not shown) also can be positioned at the front and the rear of motorcycle 100.

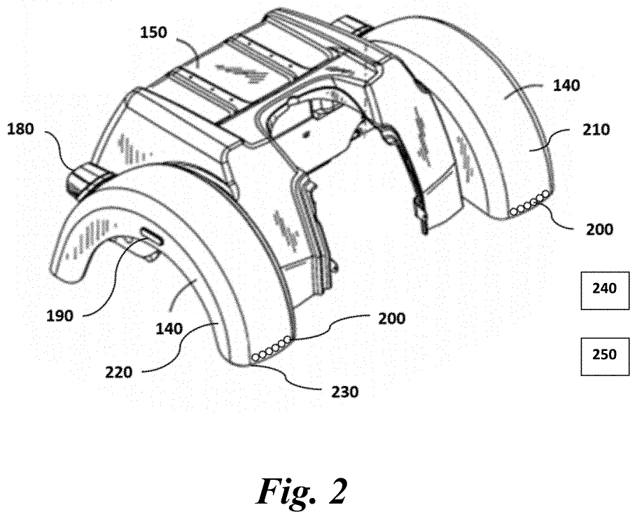

Referring now to FIG. 2 is an exploded, front perspective view of trunk body 150 of three-wheeled motorcycle 100 having a pair of rear fenders 140 fitted with the presently disclosed auxiliary lighting system 200 on a forward-facing portion 210 of each respective rear fender 140. In one embodiment as illustrated in FIG. 2, auxiliary lighting system 200 is affixed to a bottom portion 230 of the forward-facing portion 210 of rear fender 140.

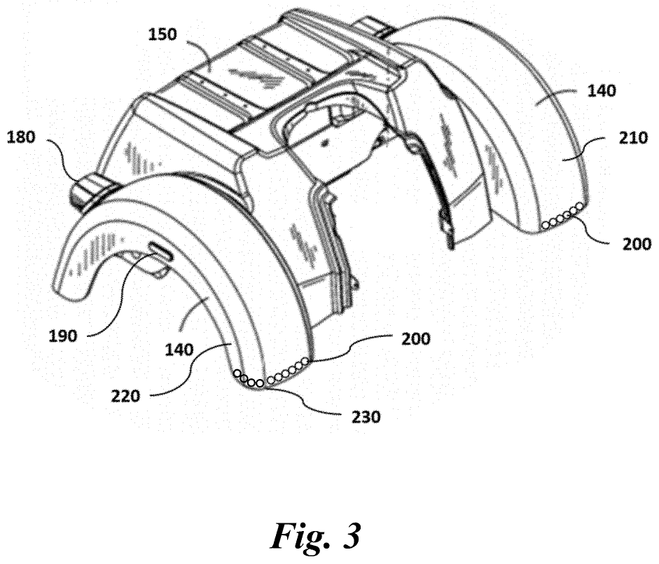

Referring now to FIG. 3, is a front perspective view of trunk body 150 of the three-wheeled motorcycle 100 of FIG. 2 having two rear fenders 140 fitted with the presently disclosed auxiliary lighting system 200 on the forward-facing portion 210 and side portion 220 of each rear fender 140.

Auxiliary lighting system 200 can be affixed to any portion of the forward-facing portion 210 and/or the side-portion 220 of each rear fender 140. Auxiliary lighting system 200 can be affixed to the forward-facing portion 210 and/or the side-portion 220 of each rear fender 140 using a fastener, e.g., a bolt, screw, rivet, or zip tie, or an adhesive.

In one embodiment, auxiliary lighting system 200 comprises one or more light elements. In one embodiment, as illustrated in FIG. 2 and FIG. 3, the one or more light elements comprise a plurality of light-emitting diodes (LEDs). In one embodiment, the plurality of LEDs comprise a flexible LED light strip or light tube. In one embodiment, the plurality of LEDs comprises an LED cluster. One of ordinary skill in the art would recognize that auxiliary lighting system 200 is not limited to comprising a plurality of LEDs and can comprise one or more lights selected form the group consisting of a halogen light and a high-intensity discharge lamp.

In embodiments in which the auxiliary lighting system comprises a plurality of LEDs, the LEDs can include one or more colors selected from the group consisting of white, blue, ice blue, red, green, pink, purple, orange, yellow, and combinations thereof, e.g., they can be multicolored. In embodiments, in which the auxiliary lighting system comprises a halogen light or high-intensity discharge lamp, the auxiliary lighting system can further comprise a lens, which can include a clear lens or a colored lens, e.g., red, yellow, orange, and the like.

The auxiliary lighting system can be directly wired into the existing motorcycle electrical system or can have its own power source 240, e.g., an external battery or solar panel. Auxiliary lighting system 200 is configured to be electrically controlled to be activated and deactivated. Auxiliary lighting system 200 can be controlled through the existing motorcycle electrical system, e.g., it can be controlled with the turn signal switch of the motorcycle, or can be controlled by a standalone switching system 250 or controlled through an external device, e.g., a smartphone. Auxiliary lighting system 200 can be configured to be on constantly, can flash on and off, or can be turned off. Auxiliary lighting system 200 can further comprise a twilight sensor and can be configured to automatically turn on when the ambient light level reaches a predetermined value.

The presently disclosed auxiliary lighting system can be adapted for use as running lights, parking lights, directional indicators, e.g., turn signals, emergency flashers, and the like.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

1. An auxiliary lighting system for a three-wheeled motorcycle, wherein the three-wheeled motorcycle has two rear wheels and a single front wheel in a delta configuration, the two rear wheels each partially enclosed by a rear fender, wherein the auxiliary lighting system comprises a plurality of light-emitting diodes (LEDs) adapted to be affixed to a bottom portion of a forward-facing portion and/or side portion of each rear fender and configured to make each rear fender visible to incoming traffic.

2. (canceled)

3. The auxiliary lighting system of claim 1, wherein the plurality of LEDs is selected the group consisting of a flexible LED light strip, LED light tube, and LED cluster.

4. The auxiliary lighting system of claim 3, wherein the plurality of LEDs have a color selected from the group consisting of white, blue, ice blue, red, green, pink, purple, orange, yellow, and combinations thereof.

5. (canceled)

6. (canceled)

7. The auxiliary lighting system of claim 1, wherein the auxiliary lighting system is directly wired into an electrical system of the three-wheeled motorcycle or has a separate power source.

8. The auxiliary lighting system of claim 7, wherein the separate power source is selected from an external battery and a solar panel.

9. The auxiliary lighting system of claim 1, wherein the auxiliary lighting system is configured to be electrically controlled to be activated and deactivated.

10. The auxiliary lighting system of claim 9, wherein the auxiliary lighting system is electronically controlled through an existing control system of the three-wheeled motorcycle or is controlled by a standalone switching system.

11. The auxiliary lighting system of claim 10, wherein the auxiliary lighting system is electronically controlled through a standalone switching system and wherein the standalone switching system comprises a smartphone.

12. The auxiliary lighting system of claim 10, further comprising a twilight sensor.

13. The auxiliary lighting system of claim 1, wherein the auxiliary lighting system is adapted for use as running lights, parking lights, directional indicators, emergency flashers, and combinations thereof.
